(19) United States
(12) Patent Application Publication
(10) Pub. No.: US 2012/0216761 A1
(43) Pub. Date: Aug. 30, 2012

(54) COOLING DEVICE FOR ENGINE

(75) Inventors: Daishi Takahashi, Susono-shi (JP); Shinichiro Nogawa, Mishima-shi (JP)

(73) Assignee: TOYOTA JIDOSHA KABUSHIKI KAISHA, Toyota-shi, Aichi-ken (JP)

(21) Appl. No.: 13/502,250

(22) PCT Filed: Oct. 19, 2009
(86) PCT No.: PCT/JP2009/068022

§ 371 Date: Apr. 16, 2012

(51) Int. Cl. F01P 7/14; F02F 1/40

(52) U.S. Cl. 123/41.02; 123/41.82 R

(57) ABSTRACT

A cooling apparatus includes an engine equipped with a cylinder block and a cylinder head, a flow rate control valve capable of suppressing a cooling capacity of the cylinder head without suppressing a cooling capacity of the cylinder block, and control means that performs a control to suppress the cooling capacity of the cylinder head by controlling the flow rate control valve. The flow rate control valve is cooling capacity control means that controls the cooling capacity of the cylinder head by controlling the flow rate of cooling water that flows through a head side W/J formed in the cylinder head.

### TECHNICAL FIELD

The present invention relates to an engine cooling apparatus.

### BACKGROUND ART

Conventionally, an engine is generally cooled by cooling water. It is known that the thermal load of the engine, particularly, that of the cylinder head increases in operation.

In this regard, for example, Patent document 1 discloses an engine cooling apparatus that accelerates the warming-up of the engine when the engine is cold and is capable of appropriately cooling the engine when the engine is hot.

Specifically, the engine cooling apparatus accelerates the engine warm-up by flowing cooling water through a cylinder head and a cylinder block in this order without flowing the cooling water through a radiator when the engine is cold. That is, this engine cooling apparatus accelerates the warming-up when the engine is cold by utilizing a high thermal load of the cylinder head.

Also, this engine cooling apparatus is intended to appropriately cool the engine when the engine is hot by flowing cooling water through the cylinder head (or through a radiator and the cylinder head in this order as necessary) under low load conditions and flowing cooling water through the radiator, the cylinder head and the cylinder block in this order under high load conditions. That is, this engine cooling apparatus is intended to ensure the appropriateness of cooling when the engine is hot by giving priority to cooling of the cylinder head having a high thermal load.

### PRIOR ART DOCUMENT

### Patent Document

Patent Document 1: Japanese Unexamined Patent Application Publication No. 2004-270652

### DISCLOSURE OF THE INVENTION

### Problems to be Solved by the Invention

Incidentally, an engine, especially, a spark-ignited internal combustion engine generates much heat which is caused by an exhaust loss or a cooling loss and which is not used for the actual work, as shown in FIG. 11. It is very important to reduce the cooling loss having a big ratio in the whole energy loss for the improvement of the heat efficiency (the mileage). However, it is not always easy to reduce the cooling loss and to use heat effectively. This prevents the improvement of heat efficiency.

For example, the reason it is difficult to reduce the cooling loss is that a general engine cannot partially change the heat transfer state. That is, it is difficult to cool a part necessary to be cooled by only the necessary degree, in consideration of the structure of the general engine. Specifically, to change the heat transfer state of the engine, the flow rate of the cooling water is changed in response to the engine speed by a mechanical water pump driven by the output of the engine. However, even if the adjustable water pump temporarily changing the flow rate is used as the water pump entirely regulating the flow rate of the cooling water, the heat transfer state cannot be partially changed in response to an engine driving state.

Also, for example, it is conceivable that the heat insulation of the engine is raised for reducing a cooling loss. In this case, a large reduction of the cooling loss can be expected as shown in FIG. 12. However, the improvement of the heat insulation also increases the inner wall temperature of the combustion chamber at the same time. Further, in this case, this increases the temperature of the air-fuel mixture, thereby causing a problem of knocking.

Thus, the present invention has been made in view of the above circumstances and has an object to provide an engine cooling apparatus capable of both reduction in cooling loss and improvement in knocking by partially changing the heat transfer of the engine in a rational manner.

### Means for Solving the Problems

According to an aspect of the present invention, there is provided an engine cooling apparatus comprising an engine provided with a cylinder block and a cylinder head; cooling capacity control means capable of suppressing a cooling capacity of the cylinder head without suppressing a cooling capacity of the cylinder block; and control means performing a control to suppress the cooling capacity of the cylinder head by controlling the cooling capacity control means.

Also, the present invention preferably has a structure such that a first cooling medium passageway is formed in the cylinder block, and a second cooling medium passageway that is formed in the cylinder head and is incorporated into a second cooling medium circulation passageway different from a cooling medium circulation passageway into which the first cooling medium passageway is incorporated; the cooling capacity control means controls a flow rate of a cooling medium that flows through the second cooling medium passageway to control the cooling capacity of the cylinder head; and the control means performs the control in a case where a driving state of the engine is a low rotation and high load state.

Also, the present invention preferably has a structure such that the first and second cooling medium passageways are incorporated into mutually different cooling medium circulation passageways, and the cooling medium that flows through the second cooling medium passageway is oil.

Also, the present invention preferably has a structure such that the first cooling medium passageway includes a first partial cooling medium passageway in the cylinder block in a periphery of a cylinder provided in the cylinder block, and an upstream portion of the first partial cooling medium passageway is provided so as to correspond to a portion of a wall surface of the cylinder that is hit by intake air flowing into the cylinder.

### Effects of the Invention

According to the present invention, both reduction in cooling loss and improvement in knocking can be achieved by partially changing the heat transfer of the engine in a rationale manner.

### BRIEF DESCRIPTION OF THE DRAWINGS

FIG. 1 is a schematic view of an engine cooling apparatus (hereinafter, simply referred to as cooling apparatus) 1A;

FIG. 2 is a schematic view of a cross section of a cylinder of an engine 50A;

FIG. 3 is a schematic view of an ECU 70A;

FIG. 4 is a schematic view of categories of the engine driving state;

FIG. 5 is a schematic view of a flowchart of an operation of the ECU 70A;

FIG. 6 is a schematic view of a heat transfer ratio and a surface area ratio of a combustion chamber 55 in response to a crank angle;

FIG. 7 is a schematic view of a heat efficiency of the cooling apparatus 1A in response to a load; additionally, for comparison, FIG. 7 also shows a cooling apparatus 1X substantially identical to the cooling apparatus 1A, except that a flow rate control valve 14 is not provided in the cooling apparatus 1X;

FIG. 8 is a schematic view of a cooling apparatus 1B;

FIG. 9 is a view of a flowchart of an operation of the ECU 70B;

FIG. 10 is a schematic view of a cross section of a cylinder of an engine 503;

FIG. 11 is a view of a breakdown of the general heat balance of a spark-ignited internal combustion engine in each case of full load and partial load; and

FIG. 12 is a view of inner wall temperature and heat transmissivity of the cylinder in each case of the normal and the high insulation, additionally, FIG. 9 illustrates a case where the cylinder wall thickness is increased and its material is changed and a case where air insulation is performed with high performance, as the case of the high insulation; and FIG. 9 illustrates a general engine provided with a cooling water circulation passageway of one system through which cooling water flows from a cylinder block lower portion to a head against gravitational force.

### MODES FOR CARRYING OUT THE INVENTION

Embodiments according to the present invention will be described in detail with reference to the drawings.

### Embodiment 1

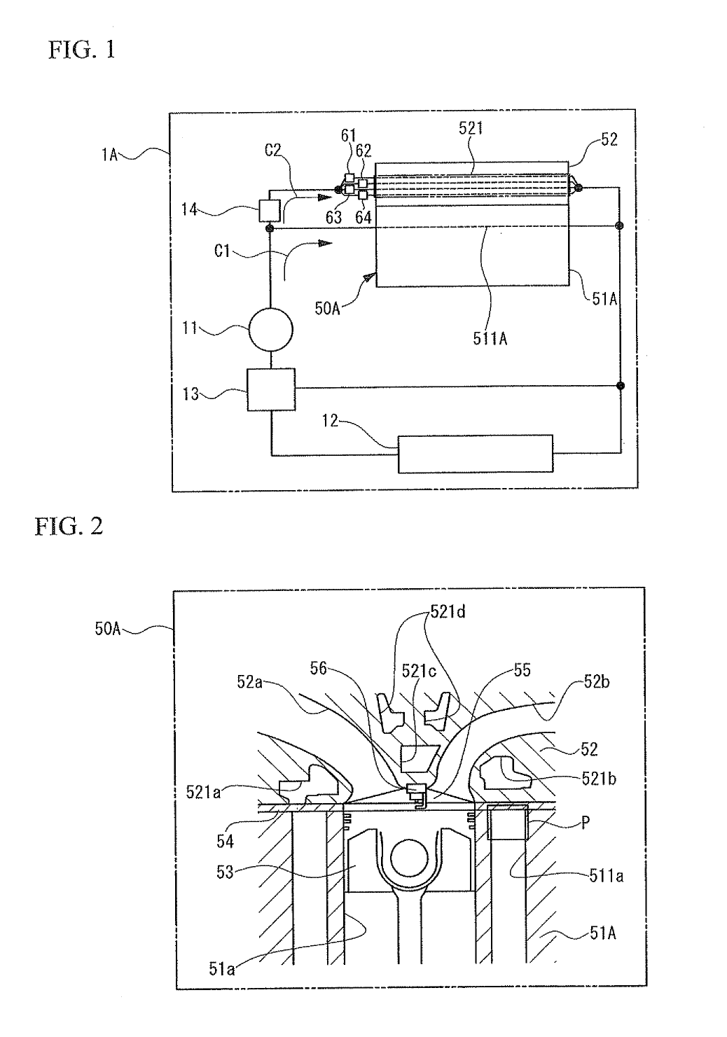

A cooling apparatus 1A shown in FIG. 1 is mounted on a vehicle not illustrated, and is provided with a water pump (hereinafter, referred to as W/P) 11, a radiator 12, a thermostat 13, a flow rate control valve 14, an engine 50A, and first through fourth partial flow rate control valves 61 through 64. The W/P 11 corresponds to cooling medium pressure feeding means, and is an adjustable W/P feeding the cooling water as a cooling medium with pressure and changing the flow rate thereof. The cooling water fed by the W/P 11 with pressure is supplied to the engine 50A.

The engine 50A includes a cylinder block 51A and a cylinder head 52. The cylinder block 51A is provided with a block side water jacket (hereinafter, referred to as block side W/J) 511 A, which is a first cooling medium passageway. The block side W/J 511 A forms a single cooling system in the cylinder block 51A. On the other hand, the cylinder head 52 is provided with a head side water jacket (hereinafter, referred to as head side W/J) 521, which is a second cooling medium passageway. The head side W/J 521 forms multiple (herein, four) different cooling systems at the cylinder head 52. Specifically, the cooling water fed by the W/P 11 with pressure is supplied to the block side W/J 511A and the head side W/J 521.

In this regard, multiple cooling water circulation passageways are provided in the cooling apparatus 1A. For example, for a cooling water circulation passageway, there is a block side circulation passageway C1 into which the block side W/J 511A is incorporated. After the cooling water is discharged from the W/P 11, the cooling water flowing into this block side circulation passageway C1 flows through the block side W/J 511 A, and returns to the W/P 11 either via the thermostat 13 or via the radiator 12 as well as the thermostat 13. The radiator 12 is a heat exchanger, and exchanges heat between the flowing cooling water and air to cool the cooling water. The thermostat 13 switches circulation passageways communicating with the entrance side of the W/P 11. Specifically, the thermostat 13 permits the circulation passageway bypassing the radiator 12 to be in the communication state, when the cooling water temperature is less than a predetermined value. The thermostat 13 permits the circulation passageway circulating with the radiator 12 to be in a communication state, when the cooling water temperature is equal to or more than the predetermined value.

Also, for example, for a cooling water circulation passageway, there is a head side circulation passageway C2 which is the circulation passageway into which the head side W/J 521 is incorporated. After the cooling water is discharged from the W/P 11, the cooling water flowing into this head side circulation passageway C2 flows into the flow rate control valve 14, at least any one of the partial flow rate control valves 61 through 64, and at least any one of the four cooling water systems formed in the head side W/J 521, and then returns to the W/P 11 either via the thermostat 13 or via the thermostat 13 and the radiator 12.

The flow rate control valve 14 is provided in a portion of the head side circulation passageway C2 that is located after the circulation passageway branches into the circulation passageways C1 and C2 and is located at the upstream side of the cylinder head 52, and is provided more specifically at the upstream sides of the first through fourth partial flow rate control valves 61 through 64. The flow rate control valve 14 corresponds to cooling capacity adjusting means which can adjust the cooling capacity of the cylinder head 52. In this regard, the flow rate control valve 14 corresponds to cooling capacity adjusting means which can entirely adjust the cooling capacity of the cylinder head 52 by entirely controlling the flow rate of the cooling water circulating in the head side W/J 521.

Further, the flow rate control valve 14 provided in such a way corresponds to cooling capacity adjusting means which can suppress the cooling capacity of the cylinder head 52 without suppressing the cooling capacity of the cylinder block 51A. Specifically, for example, the flow rate control valve 14 serves as cooling capacity adjusting means which can suppress the cooling capacity of the cylinder head 52 without suppressing the cooling capacity of the cylinder block 51A in a high rotation and high load state in which the cooling water is flowed into the cylinder block 51A and the cylinder head 52 in a high load and high rotation state.

Further, the flow rate control valve 14 provided in the above manner corresponds to cooling capacity adjusting means which can adjust the flow rate of the cooling water circulating through in the block side W/J 511A to improve the cooling capacity of the cylinder block 51A, when the flow rate of the cooling water circulating through the head side W/J 521 is controlled to suppress the cooling capacity of the cylinder head 52.

The first through fourth partial flow rate control valves 61 through 64 are provided between the flow rate control valve 14 and the cylinder head 52 in the head side circulation passageway C2 so as to correspond to the four cooling systems of the head side W/J 521. These partial flow rate control valves 61 through 64 are cooling capacity control means that can control the cooling capacity of the cylinder head 52, and is more specifically cooling capacity control means that can partially control the cooling capacity of the cylinder head 52 by partially controlling the flow rte of the cooling water that flows through the head side W/J 521.

In the cooling apparatus 1A, after the cooling water circulating through the block side circulation passageway C1 is fed by the W/P 11 with pressure, the cooling water does not flow to the head side W/J 521 before the cooling water fully circulates. Further, in the cooling apparatus 1A, after the cooling water circulating through the head side circulation passageway C2 is pressure-fed by the W/P 11, the cooling water does not flow into the block side W/J 511 A before the cooling water fully circulates. That is, in the cooling apparatus 1A, the block side W/J 511A and the head side W/J 521 are respectively incorporated into mutually different cooling medium circulation passageways.

Next, the engine 50A will be explained in more detail. As shown in FIG. 2, a cylinder 51a is formed in the cylinder block 51A. A piston 53 is provided in the cylinder 51a. The cylinder head 52 is fixed to the cylinder head 52 through a gasket 54. The gasket 54 suppresses heat transfer from the cylinder block 51A to the cylinder head 52 due to its high heat insulation. The cylinder 51a, the cylinder head 52 and the piston 53 form a combustion chamber 55. The cylinder head 52 is provided with an intake port 52a leading intake air to the combustion chamber 55 and an exhaust port 52b exhausting combustion gases from the combustion chamber 55. A spark plug 56 is provided in the cylinder head 52 so as to substantially face the upper and center of the combustion chamber 55.

The block side W/J 511 A includes a partial W/J 511 a corresponding to a first partial cooling medium passageway. Specifically, the partial W/J 511a is provided in the periphery of the cylinder 51a. An upstream portion P of the partial W/J 511a is provided so as to correspond to a portion of the wall surface of the cylinder 51a that is hit by the intake air that has flown into the cylinder 51a. In this regard, the engine 50A generates a forward tumble flow in a cylinder, the portion that is hit by the intake air that has flow into the cylinder more specifically corresponds to the upper portion of the wall surface of the cylinder 51a and to the exhaust side.

The head side W/J 521 specifically includes multiple parts of a partial W/J 521a, a partial W/J 521b, a partial W/J 521c, and a partial W/J 521d corresponding to the second partial cooling medium passageway. The partial W/J 521a corresponds to the cooling medium passageway provided in the periphery of the intake port 52a. The partial W/J 521b corresponds to the cooling medium passageway provided in the periphery of the exhaust port 52b. The partial W/J 521c corresponds to the cooling medium passageway provided in the periphery of the spark plug 57. The partial W/J 521d corresponds to the cooling medium passageway provided for cooling a portion between the intake and exhaust ports 52a and 52b and another portion. The partial W/J 521a through the partial W/J 524a are respectively incorporated into the four cooling systems of the head side W/J 521. The first partial flow rate control valve 61 is provided so as to correspond to the partial W/J 521a, and the second partial flow rate control valve 62 is provided so as to correspond to the partial W/J 521b, the third partial flow rate control valve 63 being provided so as to correspond to the partial W/J 521c, and the fourth partial flow rate control valve 64 being provided so as to correspond to the partial W/J 521d.

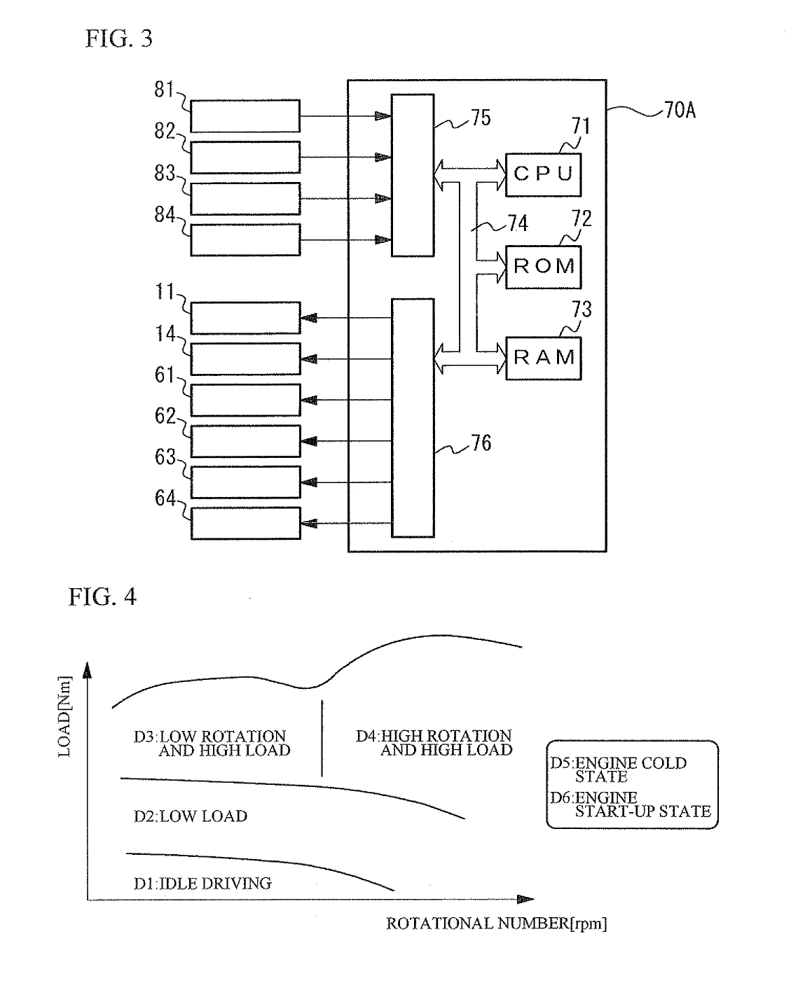

Additionally, the cooling apparatus 1A includes an Electronic Control Unit (ECU) 70A shown in FIG. 3. The ECU 70A includes a microcomputer of a CPU 71, a ROM 72, a RAM 73, and the like, and input-output circuits 75 and 76. These configurations are connected to each other via a bus 74. The ECU 70A is electrically connected with various sensors or switches such as a crank angle sensor 81 for detecting the rotational number of the engine 50A, an air flow meter 82 for measuring the amount of air intake, an accelerator opening sensor 83 for detecting the degree of an accelerator opening, and a water temperature sensor 84 for detecting the temperature of the cooling water. The ECU 70A detects the load of the engine 50A based on the outputs of the air flow meter 82 and the accelerator opening sensor 83. Also, the ECU 70A is electrically connected with various control objects such as the W/P 11, the flow rate control valve 14, and the first through fourth partial flow rate control valves 61 through 64.

The ROM 72 stores map data or programs about a variety of processing performed by the CPU 71, The CPU 71 processes based on a program stored in the ROM 72 and uses a temporary memory area of the RAM 73 as necessary, whereby the ECU 70A functions as various means such as control means, determination means, detecting means, and calculating means.

For example, the ECU 70A functionally realizes control means for controlling the cooling capacity of the cylinder head 52.

Specifically, when an engine driving state is in a high load state, the control means suppresses the cooling capacity of the cylinder head 52.

More specifically, when the engine driving state is in a low speed and high load one, the cooling capacity exerted by the head side W/J 521 is suppressed by controlling the flow rate control valve 14.

Further, the control means is realized to achieve a control for ensuring the drive of the engine 50A in the high-load driving state in addition to any other driving states.

In this regard, the engine driving state is classified into six divisions D1 to D6 as illustrated in FIG. 4, in response to the number of rotations of the engine 50A, the load thereof, the cold driving state, and the engine starting state. In control of the control means, the control means sets requirements to be satisfied in each of the divisions D1 to D6, and control indications for satisfying the set requirements.

When the engine driving state is an idle state corresponding to the division D1, two requirements are set for improving a combustion speed depending on the increase in the intake air temperature, and for increasing an exhaust gas temperature for activation of catalyst. In response to this, two control indications are set for increasing the temperatures of the intake port 52a and the upper portion of the cylinder 51a, and for increasing the temperature of the exhaust port 52b.

In this regard, to increase the temperature of the intake port 52a, for example, the flow rate control valve 14 or the partial flow rate control valve 61 is closed or is opened with a small opening.

Also, to increase the temperature of the upper portion of the cylinder 51a, for example, the W/P 11 is stopped or is driven with a low discharge volume.

Also, to increase the temperature of the exhaust port 52b, for example, the flow rate control valve 14 or the partial flow rate control valve 62 is closed or is opened with a small opening.

Further, when the engine driving state has a low load corresponding to the division D2, two requirements are set for improving the heat efficiency (reducing the cooling loss), and for improving the combustion speed by increasing the intake air temperature. In response to this, two control indications are set for the insulation of the cylinder head 52, and for the increase in the temperatures of the intake port 52a and the upper portion of the cylinder 51a.

In this regard, to insulate the cylinder head 52, for example, the flow rate control valve 14 or the partial flow rate control valves 61 through 64 are closed or opened with a small opening. Further, to increase the temperature of the intake port 52a, for example, the flow rate control valve 14 or the partial flow rate control valve 61 is closed or opened with a small opening. Furthermore, to increase the temperature of the upper portion of the cylinder 51a, for example, the W/P 11 is stopped or is driven with a low discharge volume.

Further, when the engine driving state is in a low rotation and high load state corresponding to the division D3, the requirements are set for reducing the knocking and for improving the heat efficiency (reducing the cooling loss). In response to this, there are set two control indications for cooling the intake port 52a and the upper portion of the cylinder 51a and for insulating the cylinder head 52.

In this regard, in order to cool the intake port 52a, for example, the flow rate control valve 14 or the partial flow rate control valve 61 is fully opened or is opened with a great opening. Furthermore, in order to cool the upper portion of the cylinder 51a, for example, the W/P 11 is driven with the maximum discharge volume or the high discharge volume applied in the engine driving state. Also, in order to thermally insulate the cylinder head 52, for example, the flow rate control valve 14 or each of the partial flow rate control valves 61 through 64 is closed or is opened with a small opening.

When the engine driving state is in a high rotation and high load state corresponding to the division D4, two requirements are set for ensuring reliability and reducing the knocking. In response to this, two control indications are set for cooling the periphery of the spark plug 56, the portion between the intake and exhaust ports 52a and 52b, and for cooling the intake port 52a.

In this regard, to cool the periphery of the spark plug 56, the portion between the intake and exhaust ports 52a and 52b, and the exhaust port 52b, for example, the flow rate control valve 14 or the partial flow rate control valve 63, the partial flow rate control valve 64 and the partial flow rate control valve 62 are fully opened. Further, in order to cool the intake port 52a, for example, the flow rate control valve 14 or the partial flow rate control valve 61 is fully opened. The W/P 11 may be driven with the maximum discharge volume applied in the engine driving state.

When the engine is cold so as to correspond to the division D5, two requirements are set for accelerating warm-up of the engine and improving the combustion speed depending on the increase in the intake air temperature. In response to this, two control indications are set for accelerating the heat transfer of the cylinder head 52 and for increasing the temperatures of the intake port 52a and the upper portion of the cylinder 51a.

In this regard, in order to accelerate the heat transfer of the cylinder head 52, for example, the partial flow rate control valves 62 and 63 associated with portions having large thermal loads are opened with large openings in consideration of the large contribution to the heat which the cooling water receives in the cylinder head 52.

Also, in order to increase the temperature of the intake port 52a, for example, the flow rate control valve 14 or the partial flow rate control valve 61 is closed, or is opened with a small opening. Also, in order to increase the temperature of the upper portion of the cylinder 51a, for example, the W/P 11 is stopped or is driven with a low discharge volume.

When the engine is started in the division D6, two requirements are set for improving the ignition property and for accelerating the fuel vaporization. In response to this, two control indications are set for increasing the temperature of the intake port 52a, and for increasing the temperatures of the periphery of the spark plug 56 and the cylinder 51a.

In this regard, in order to increase the temperature of the intake port 52a, for example, the flow rate control valve 14 or the partial flow rate control valve 61 is closed, or is opened with a small opening.

Also, in order to increase the temperature of the periphery of the spark plug 56, for example, the flow rate control valve 14 or the partial flow rate control valve 63 is closed or is opened with a small opening.

Further, in order to increase the temperature of the cylinder 51a, for example, the W/P 11 is stopped or is driven with a low discharge volume.

Meanwhile, in the cooling apparatus 1A, the control means is realized to control the W/P 11 to basically increase the discharge volume as the number of the rotation of the engine 50A increases, in light of the consistency or the simplification of the entire control and to control the partial flow rate control valves 61 through 64 to be fully opened primarily. On the other hand, the flow rate control valve 14 is controlled in the following manner in detail.

That is, the control means is realized to control the flow rate control valve 14 to close, when the engine driving state is an idle state corresponding to the division Dl, is a low load state corresponding to the division D2, is a cold state corresponding to the division D5, or is a starting state corresponding to the division D6.

When the engine driving state is in a low rotation and high load state corresponding to the division D3, the control means is realized to control the flow rate control valve 14 to close, or to open in such a manner that the cooling water is suppressed from flowing through the cylinder head 52 and from boiling in the cylinder head 52 (hereinafter, referred to as boiling suppression manner).

Further, when the engine driving state is in a high rotation and high load state corresponding to the division D4, the control means is realized to control the flow rate control valve 14 to be fully open.

In this regard, in order to control the flow rate control valve 14 in the boiling suppression manner at the time when the engine driving state is in the low rotation speed and high load state corresponding to the division D3, specifically, the control means may control the flow rate control valve 14 to open with a necessity minimum opening so as to suppress the cooling water from boiling under all conditions. Further, the control means may detect or estimate the temperature of the cooling water flowing through the cylinder head 52, and may control the flow rate control valve 14 to intermittently open in response to the temperature of the cooling water. Furthermore, the control means may control the flow rate control valve 14 to open under a condition of a given rotation number or more. In the suppression of the cooling water capacity of the cylinder head 52, the cooling water can be suppressed from boiling and the flow rate control valve 14 can be suppressed from opening more than necessary.

In the cooling apparatus 1A in the division D3, the flow rate control valve 14 decreases the flow rate of the cooling water flowing through the cylinder head 52 to locally decrease the flow rate of the cooling water flowing through the engine 50A, under the control of the control means.

The cooling apparatus 1A suppresses the flow of the cooling water through the cylinder head 52 in a case where the flow rate control valve 14 is not fully opened, thereby suppressing the cooling capacity of the cylinder head 52. In this regard, the flow rate control valve 14 is closed or is opened in the boiling suppression manner in the cooling apparatus 1A, whereby the cooling capacity of the cylinder head 52 is suppressed.

Additionally, since the consistency or the simplification of the entire control in the cooling apparatus 1A is taken into consideration, the control means is realized to close the flow rate control valve 14 in the divisions D1, D2, D5 and D6. However, the control means is not limited to the above but may be realized to suitably control the W/P 11, the flow rate control valve 14 and the partial flow rate control valves 61 through 64 on the basis of the above-described control indications and to thus perform mutually different controls in the divisions D1, D2, D5 and D6. As a result of this, it is possible to more suitably drive the engine 50A in the divisions D1, D2, D5 and D6.

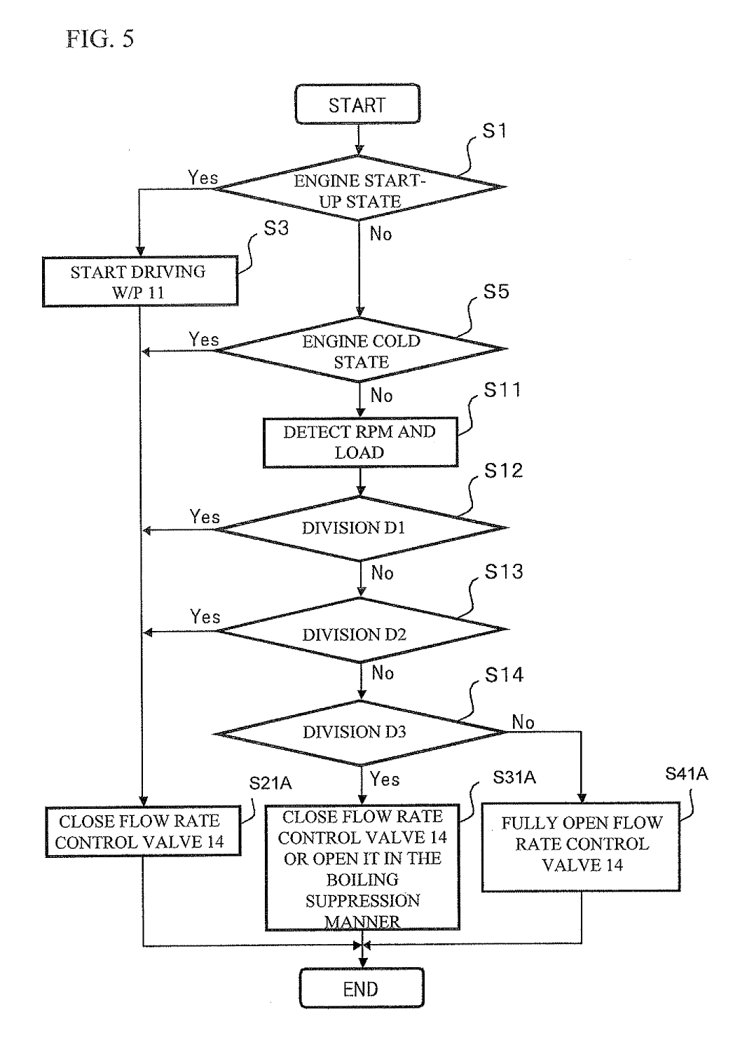

The processing performed in the ECU 70A will be described with reference to a flowchart shown in FIG. 5. The ECU 70A determines whether or not the engine 50A has just been started up (step S1). If a positive determination is made, the ECU 70A starts to drive the W/P 11 (step S3), and controls the flow rate control valve 14 to open (step S21A). On the other hand, if a negative determination is made in step S1, the ECU 70A determines whether or not the engine 50A is cold (step S5). To determine whether or not the engine 50A is cold may be performed by, for example, determining whether the cooling water temperature is equal to or less than a predetermined value (for example, 75° C.). If a positive determination is made in step S5, the processing proceeds to step S21. On the other hand, if a negative determination is made in step S5, the ECU 70A detects the rotational number or the load of the engine 50A (step S11).

The ECU 70A determines the division corresponding to the detected rotation number and load (from steps S12 to S14). Specifically, when the division corresponds to the division D1, the processing continues to step S21 from the positive determination in S12. When the division corresponds to the division D2, the processing continues to step S21 from the positive determination in S13. In contrast, when the division corresponds to the division D3, the processing continues to step 531 from the positive determination in S14. In this case, the ECU 70A controls the flow rate control valve 14 to close or open in the boiling suppression manner (step S31A). Further, when the division corresponds to the division D4, the processing continues to step S4A1 from the negative determination in S14. In this case, the ECU 70A controls the flow rate control valve 14 to fully open (step S41A).

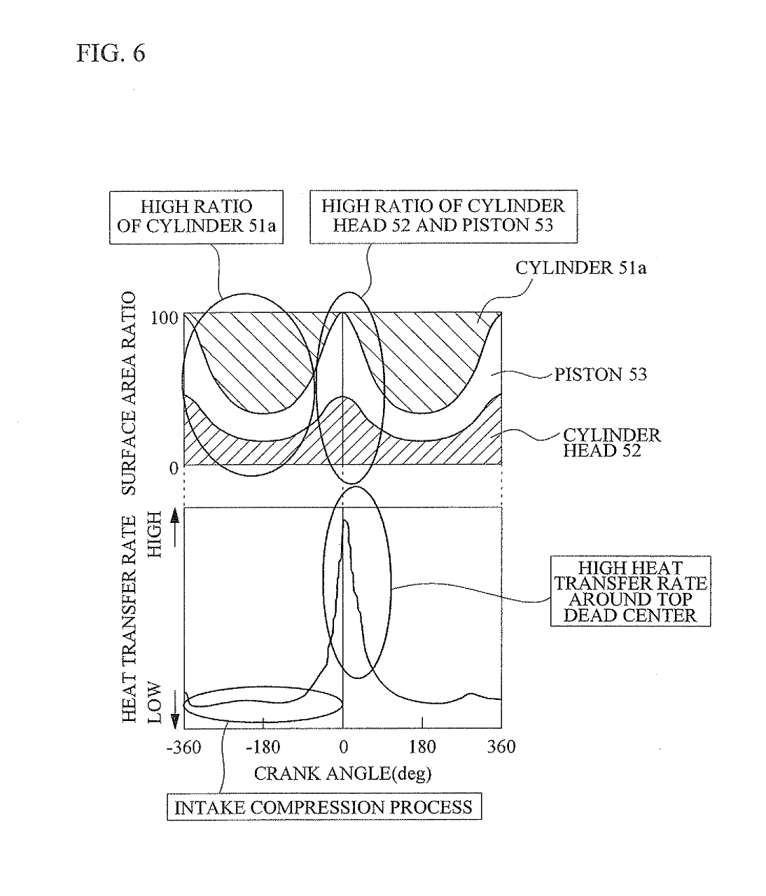

Next, the function and effect of the cooling apparatus 1A will be described. Now, FIG. 6 shows heat transfer rates and surface area ratios of the combustion chamber 55 depending on the crank angle of the engine 50A. As illustrated in FIG. 6, the heat transfer rate rises around the top dead center in the compression stroke. The surface area ratio between the cylinder head 52 and the piston 53 rises around the top dead center in the compression stroke. It is thus understood that the temperature of the cylinder head 52 greatly influences the cooling loss. On the other hand, knocking depends on the compression end temperature. It is recognized that the surface area ratio of the cylinder 51a is great in the intake compression stroke that influences the compression end temperature. It is thus understood that the temperature of the cylinder 51a greatly influences knocking.

In view of this knowledge, in the cooling apparatus 1A, the flow rate control valve 14 is closed or is opened in the boiling suppression manner, when the engine driving state is in a low rotation and high load state. Therefore, the flow rate of the cooling water flowing through the head side W/J 521 is limited, whereby the cooling capacity of the cylinder head 52 can be suppressed and the cooling loss can be reduced.

On the other hand, the generation of knocking is worried about in this case. Correspondingly, the cooling apparatus 1A controls the flow rate control valve 14 capable of suppressing the cooling capacity of the cylinder head 52 without suppressing the cooling capacity of the cylinder block 51A, thereby limiting the flow rate of the cooling water flowing through the head side W/J 521. For this reason, the cooling apparatus 1A can maintain cooling of the cylinder 51a, thereby suppressing the knocking.

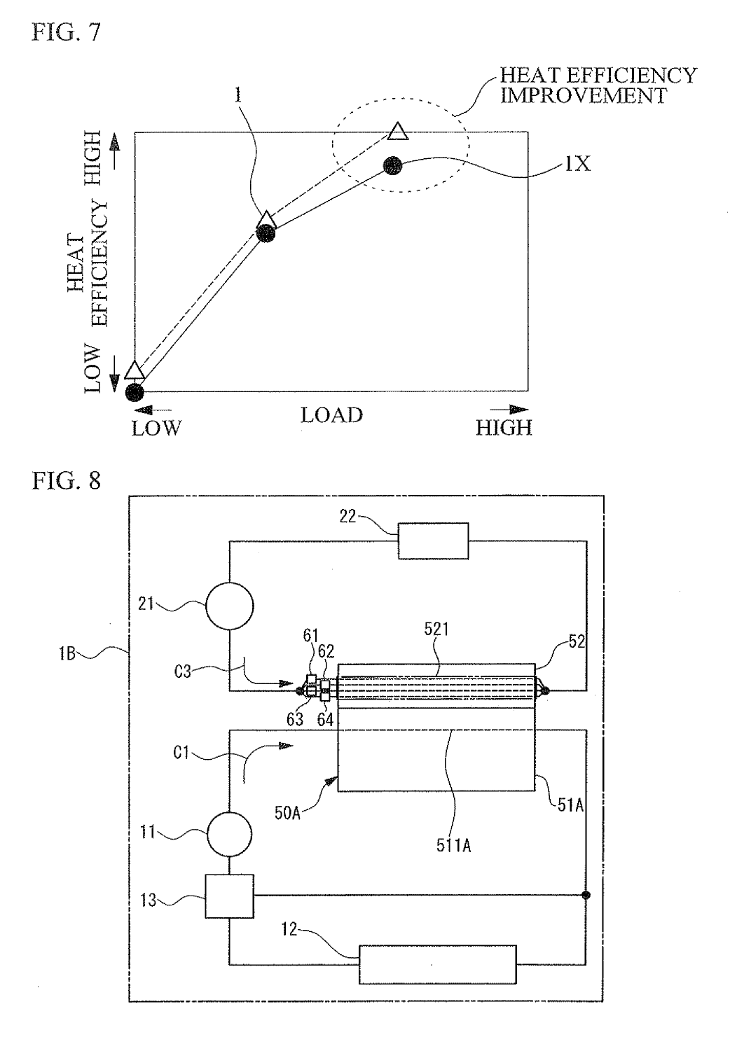

That is, in the cooling apparatus 1A, the heat transfer state is partially changed in a rational manner based on the above knowledge, thereby insulating the cylinder head 52 (the reduction of the cooling loss). Simultaneously, the cylinder block 51A is cooled the generation of knocking is thus suppressed. Such a way ensures both of the reduction of the cooling loss and the knocking characteristics, thereby improving the heat efficiency as illustrated in FIG. 7.

Further, in the cooling apparatus 1A, the upstream portion P of the partial W/J 511a is provided so as to correspond to the portion of the wall surface of the cylinder 51a that is hit by the intake air flowing into the cylinder. Thus, the cooling apparatus 1A is capable of effectively cooling the intake air and suitably suppressing the occurrence of knocking.

Furthermore, in the cooling apparatus 1A, when the flow rate control valve 14 controls the flow rate of the cooling water flowing through the head side W/J 521 to suppress the cooling capacity of the cylinder head 52, the flow rate of the cooling water flowing through the block side W/J 511 A is adjustable to increase the cooling capacity of the cylinder block 51A. Additionally, the intake air can be cooled in the cooling apparatus 1A, whereby knocking can be more suitably suppressed.

The cooling apparatus 1A can primarily improve the heat efficiency in the low rotation and high load state, and also can ensure the driving of the engine 50A in another driving state. In this regard, in the high rotation and high load state, the cooling apparatus 1A can ensure the reliability and reduction of knocking, and can further reduce the heat load applied to the catalyst caused by reduction in the exhaust gas temperature. For this reason, the cooling apparatus 1A can improve the heat efficiency in the entire driving state of the engine 50A in addition to the specific driving state.

Also, when the engine driving state is a low rotation and high load state, the control means may be realized to fully open the flow rate control valve 14 and to open the partial flow rate control valves 61 through 64 in the boiling suppression manner instead of the flow rate control valve 14. Also, when the engine driving state is a low rotation and high load state, the control means may be realized to fully open the flow rate control valve 14 and to intermittently open any of the partial flow rate control valves 61 through 64 (for example, the partial flow rate control valves 62 and 63 corresponding to portions with large thermal loads) with a small opening from the fully closed state. It is thus possible to suitably ensure the reliability of the cylinder head 52.

### Embodiment 2

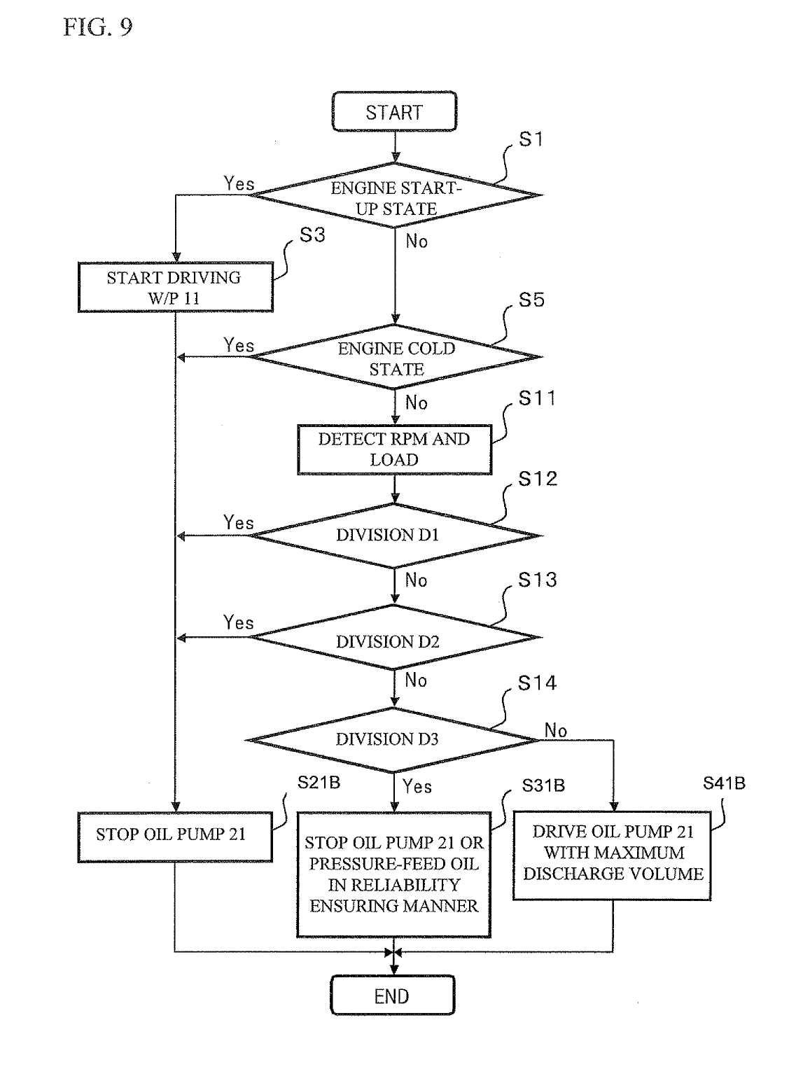

As illustrated in FIG. 8, a cooling apparatus 1B in accordance with the present embodiment is substantially the same as the cooling apparatus 1A except that the head side circulation passageway C2 is replaced with an oil circulation passageway C3 for circulating oil as a cooling medium into which the head side W/H 521 is incorporated, and an oil pump 21 is provided instead of the flow rate control valve 14, and that an oil cooler 22 is further provided and the ECU 70A is replaced with an ECU 70B, as will be described later.

The oil pump 21 and the oil cooler 22 are incorporated into the oil circulation passageway C3. The oil pump 21, which is a variable oil pump, feeds oil with pressure, and varies the flow rate of the oil. The oil cooler 22 is a heat exchanger, and cools the oil by exchanging heat between the oil flowing through the head side W/J 521 and air.

The oil circulation passageway C3 is configured so that the oil pressure-fed by the oil pump 21 passes through the head side W/J 521, and then returns to the oil pump 21 via the oil cooler 22. Thus, in the cooling apparatus 1B, the block side circulation passageway C1 and the oil circulation passageway C3 are mutually independent cooling water medium circulation passageways. The oil pump 21 provided in the oil circulation passageway C3 independent of the block side circulation passageway C1 is not only cooling capacity control means capable of controlling the cooling capacity of the cylinder head 52, but also cooling capacity control means capable of suppressing the cooling capacity of the cylinder head 52 without suppressing the cooling capacity of the cylinder block 51A.

The ECU 70B is substantially the same as the ECU 70A except that the oil pump 21 is electrically connected as a control object instead of the flow rate control valve 14, and the control means is realized so as to control the oil pump 21 instead of the flow rate control valve 14. Thus, an illustration of the ECU 70B is omitted. The oil pump 21 is controlled so that the ECU 70B realizes the control means to specifically perform the following control.

The control means is realized to perform a control to stop the oil pump 21 in a case where the engine driving state is the idle state corresponding to the division D1, in a case where the engine driving state is a low load state corresponding to the division D2, when the engine is cold in the division D5, and when the engine starts up in the division D6.

Further, when the engine driving state is in a low rotation and high load state corresponding to the division D3, the control means is realized to drive the oil pump 21 to feed the oil with pressure in such a manner as to ensure the reliability of the cylinder head 52 while stopping the oil pump 21 or suppressing the flow of the oil into the cylinder head 52 (hereinafter, referred to as a reliability ensuring manner).

Further, when the engine driving state is in a high rotation and high load state corresponding to the division D4, the control means is realized to drive the oil pump 21 with the maximum discharge volume applied in the engine driving state.

In this regard, when the engine driving state is a low rotation and high load state corresponding to the division D3, in a control to drive the oil pump 21 to feed the oil with pressure in the reliability ensuring manner, the control means may drive the oil pump 21 with the minimum discharge volume capable of ensuring the reliability of the cylinder head 52 under all conditions, or may detect or estimate the temperature of the oil flowing through the cylinder head 52 and intermittently drive the oil pump 21 on the basis of the oil temperature thus obtained, or may drive the oil pump 21 over a predetermined number of rotations. Thus, in the suppression of the cooling capacity of the cylinder head 52, it is possible to ensure the reliability of the cylinder head 52 and suppress the oil pump 21 from being driven more than necessary.

In the cooling apparatus 1B, under the control of the control means, the flow rate of the oil passing through the engine 50A is locally decreased by lowering the flow rate of the oil passing through the cylinder head 52 by the oil pump 21 in the division D3.

In the cooling apparatus 1B, when the oil pump 21 is not driven with the maximum discharge volume applied in the engine driving state, the cylinder head 52 has a suppressed cooling capacity. More specifically, in the cooling apparatus 1B, the cylinder head 52 has a suppressed cooling capacity in a case where the oil pump 21 is stopped or the oil pump 21 is driven to feed the oil with pressure in the reliability ensuring manner.

Also, in the cooling apparatus 1B, the control means may be realized to suitably control the W/P 11, the oil pump 21 and the partial flow rate control valves 61 through 64 on the basis of the above-described control indications and to thus perform mutually different controls in the divisions D1, D2, D5 and D6. As a result of this, it is possible to more suitably drive the engine 50A in the divisions D1, D2, D5 and D6.

Next, a description is given of an operation of the ECU 70B with reference to a flowchart of FIG. 9. The present flowchart is the same as the flowchart illustrated in FIG. 5 except that steps S21B, S318 and S41B are respectively substituted for steps S21A, S31A and S41A. Therefore, these steps are specifically described here. Subsequent to step S3, when a positive determination is made in step S5, S12 or S13, the ECU 70B stops the oil pump 21 (step S21B). When a positive determination is made in step S14, the ECU 70B stops the oil pump 21 or drives the oil pump 21 to feed the oil with pressure in the reliability ensuring manner (step S31B). When a negative determination is made in step S14, the ECU 70B drives the oil pump 21 with the maximum discharge volume applied in the engine driving state (step S41B).

Now, functions and effects of the cooling apparatus 1B are described. The cooling apparatus 1B is configured to use oil for the cooling medium that flows through the head side W/J 521, and is capable of suppressing the heat transfer as compared with the case where cooling water is used as the cooling medium. Further, since oil has a boiling point higher than cooling water, the cooling apparatus 1B is capable of suppressing boiling of the cooling medium under high load conditions. Thus, it is possible to expand the driving range in the low rotation and high load state in the cooling apparatus 1B and to further reduce the cooling loss.

Also, the cooling apparatus 1B may be varied as described below. That is, the cooling apparatus 1B may be varied so as to additionally form the head side circulation passageway C2 into which the partial W/J 521a out of the head side W/J 521 is incorporated. Also in this case, the flow rate control valve 14 may be provided like Embodiment 1, and may be controlled by the control means like Embodiment 1. It is thus possible to cool the intake air in the cylinder head 52 by cooling water even when oil is used to cool the cylinder head 52, and as a result of this, to suitably suppress the occurrence of knocking in the case where the cylinder head 52 is cooled by oil.

That is, the partial W/J 521a out of the head side W/J 521 has the effect of cooling the intake air as well as the effect of cooling the cylinder head 52. Therefore, a cooling water circulation passageway into which the partial W/J 521 a out of the head side W/J 521 is incorporated may be additionally provided so as to make it possible for the flow rate control valve 14 to control the flow rate of the cooling water passing through the partial W/J 521a and the flow rate of the cooling water passing through the block side W/J 511 with a similar tendency. It is thus possible to suitably suppress the occurrence of knocking. This may be achieved similarly in Embodiment 1.

Also, when the engine driving state is a low rotation and high load state, the control means may be realized so as to drive the oil pump 21 in the reliability ensuring manner or with the given discharge volume and to open the partial flow rate control valves 61 through 64 in the boiling suppression manner that has been described previously in Embodiment 1. Also, when the engine driving state is a low rotation and high load state, the control means is realized so as to drive the oil pump 21 in the reliability ensuring manner or with the predetermined discharge volume and to open at least any of the partial flow rate control valves 61 through 64 (for example, the partial flow rate control valves 62 and 63 corresponding to portions having large thermal loads) with a small opening from the fully closed state in an intermittent manner. Thus, the reliability of the cylinder head 52 can be ensured suitably.

### Embodiment 3

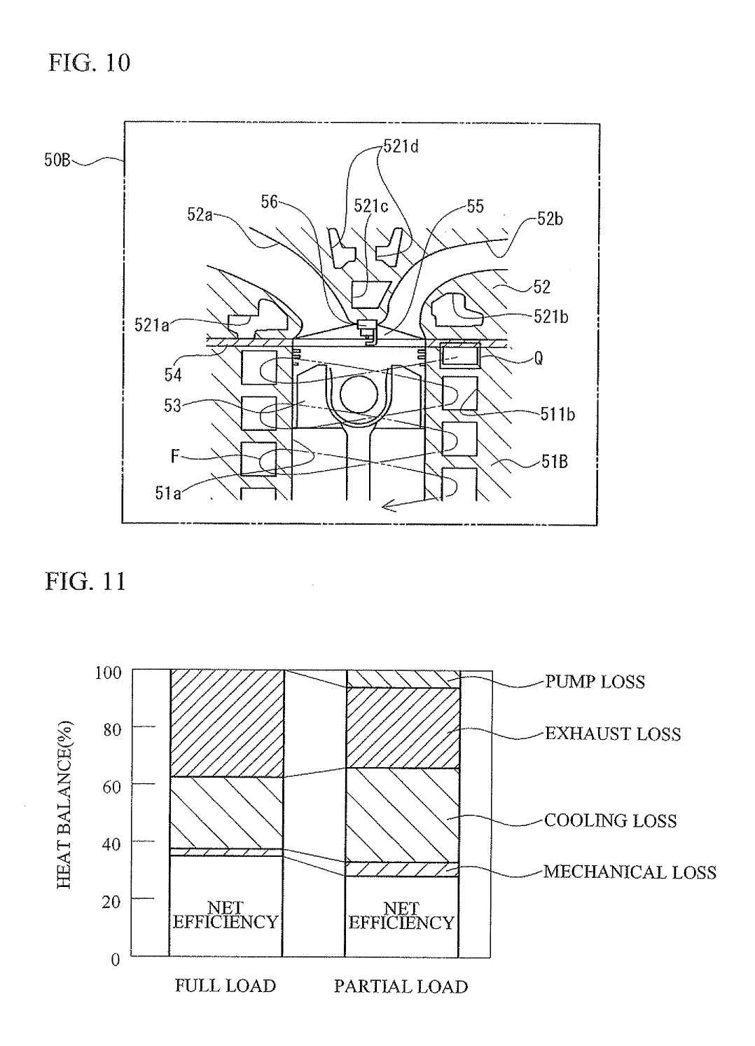

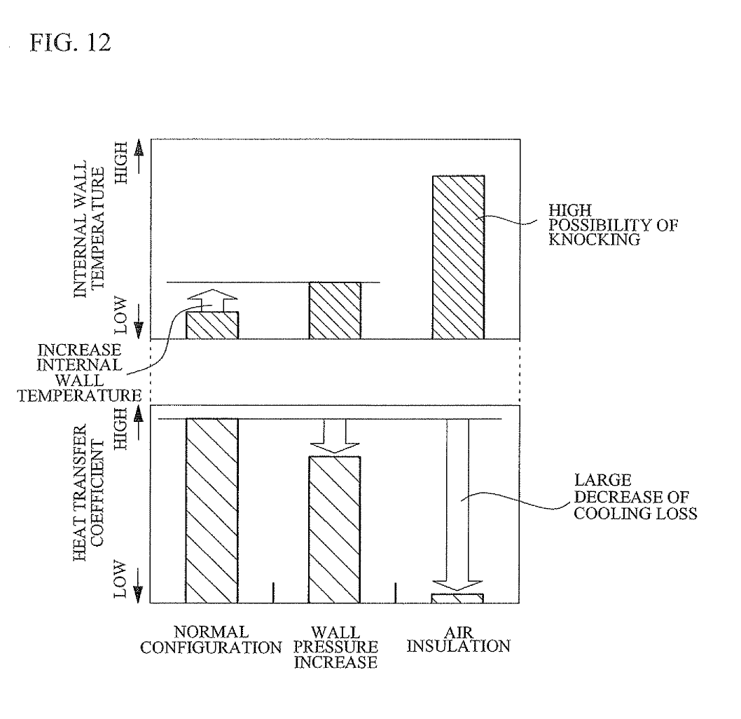

A cooling apparatus 1C in accordance with the present embodiment is substantially the same as the cooling apparatus 1A except that an engine 50B illustrated in FIG. 10 is substituted for the engine 50A. Therefore, an illustration of the cooling apparatus 1C is omitted. The engine 50B may be applied to the cooling apparatus 1B instead of the engine 50A.

The engine 50B is substantially the same as the engine 50A except that the engine 50B is equipped, instead of the cylinder block 51A, with a cylinder block 51B in which a block side W/J 511B (its illustration is omitted) is provided. The block side W/J 511E is substantially the same as the block side W/J 511A except that a partial W/J 511b is substituted for the partial W/J 511a. The partial W/J 511b is provided so that an entrance portion Q corresponds to an upper portion of the wall surface of the cylinder 51a located on the exhaust side, and is formed spirally in the periphery of the cylinder 51a towards the lower portion of the cylinder 51a from the upper portion thereof. The partial W/J 511b may be formed by forming a cylindrical space in the periphery of the cylinder 51a and inserting a sleeve having a spiral inner groove into the space.

Next, the functions and effects of the cooling apparatus 1C are described. The cooling apparatus 1C passes the cooling water through the partial W/3 511b, and is thus capable of preferentially cooling the upper portion of the wall surface of the cylinder 51a located on the exhaust side that is hit by the intake air flowing into the cylinder. Further, the cooling apparatus 1C passes the cooling water through the partial W/J 511b spirally as indicated by an arrow F, and is thus capable of supplying the upper portion of the cylinder 51a with the cooling water having a temperature lower than that of the cooling water in the lower portion of the cylinder 51a and reducing the flow rate of the cooling water towards the lower portion of the cylinder 51a from the upper portion thereof. Thus, the cooling apparatus 1C is capable of preferentially cooling the upper portion of the cylinder 51a that is effective to cool the intake air. Thus, the cooling apparatus 1C is capable of more effectively cooling the intake air and more suitably suppressing the occurrence of knocking.

The above-described embodiments are preferable embodiments of the present invention. However, the present invention is not limited to the above-mentioned embodiments, but other embodiments and variations may be made without departing from the scope of the present invention.

For example, the above-described embodiments have explained an exemplary case where the W/P 11 is the cooling medium pressure feeding means because the driving states of the engine 50 may suitably be established. However, the present invention is not limited to this. For example, the cooling medium pressure feeding means may be a mechanical W/P that is driven by the output of the engine.

Also, since the driving states of the engine 50A may suitably be established, the above-described embodiments have explained an exemplary case where as the cooling capacity control means, the embodiments are equipped with the partial flow rate control valves 61 through 64 capable of partially controlling the cooling capacity of the cylinder head 52 as well as the flow rate control valve 14 or the oil pump 21 capable of entirely controlling the cooling capacity of the cylinder head 52.

However, the present invention is not limited to the above, but the cooling apparatus may be configured to have either cooling capacity control means capable of entirely controlling the cooling capacity of the cylinder head 52 or the partial flow rate control valves 61 through 64 capable of partially controlling the cooling capacity of the cylinder head. In this regard, in a case where there are provided a plurality of cooling capacity adjustment means capable of partially controlling the cooling capacity of the cylinder head, these cooling capacity control means may be configured to function as cooling capacity control means that entirely controls the cooling capacity of the cylinder head.

In the embodiments mentioned above, when the engine driving state is in a low rotation and high load state corresponding to the division D3, the control means controls the flow rate control valve 14 to close or open in the boiling suppression manner in Embodiment 1, and controls the oil pump 21 to stop or feed oil with pressure in the reliability ensuring manner in Embodiment 2, thereby suppressing the cooling capacity exerted as each of cooling capacities of the cylinder heads 52 by each of the head side W/J 521.

However, the present invention is not limited to this. For example, the cooling apparatus may include: a retaining means for retaining the cooling medium extracted from the second cooling medium passageway; and a cooling medium pressure feeding means for transmitting the cooling medium between the retaining means and the second cooling medium passageway. The control means may control the cooling medium pressure feeding means to at least temporally extract the cooling medium from the cylinder head, in a case where the engine driving state is in low rotation and high load state. For example, the retaining means and the cooling medium pressure feeding means respectively correspond to a heat storage tank and an electromotive pump disclosed in Japanese Unexamined Patent Application Publication No. 2009-79505. This can suitably reduce the cooling loss.

Also, the retaining means, the cooling medium pressure feeding means, and the control means may be applied, when the engine driving state is an idle state, a low load, or a cold state. In this case, there may be provided first and second retaining means, as the retaining means, in which the cooling medium extracted from the first and second cooling medium passageways. There may be provided a first cooling medium pressure feeding means, as the cooling medium pressure feeding means, which transfers the cooling medium between the first retaining means and the first cooling medium passageway. There may be provided a second cooling medium pressure feeding means, as the cooling medium pressure feeding means, which transfers the cooling medium between the second retaining means and the second cooling medium passageway. In this case, when the common cooling media is made to flow through the first and second cooling medium passageways, the first and the second retaining means may be combined to a single retainer, and the first and second cooling medium pressure feeding means may be combined to a single cooling medium pressure feeding means.

This can further improve the combustion speed, reduce the cooling loss, and accelerate the engine warming up, thereby ensuring the preferable driving of the engine.

In the above Embodiment 1, the control means controls the flow rate control valve 14 to close, when the engine driving state is in the idle state, or the starting state.

However, the present invention is not limited to this. For example, the cooling apparatus may further include a heat storage cooling medium feed means which can supply the first and second cooling medium passageways with the heat storage cooling medium. The control means may control the heat storage cooling medium feed means to supply the first and the second cooling medium passageways with the heat storage cooling medium, when the engine driving state is the idle state, or when the temperature of the heat storage cooling medium is higher than that of the cooling medium in the time of the cold state or the start up state. For example, the heat storage cooling medium feed means corresponds to a heat exchanger disclosed in the Japanese Unexamined Patent Application Publication No. 2009-208569.

Further, in this case, the control means may control the part cooling capacity adjusting means is provided for corresponding to the spark plug or the exhaust port, among the part cooling capacity adjusting means which cool partially the cooling capacity of the cylinder head, so as to control the increase in the flow rate of the heat storage cooling medium.

This can accelerate the engine warming up, reduce the unburned HC, and improve the ignition property. Consequently, the engine driving can be preferably ensured.

Embodiment 2 described above is configured to incorporate the cylinder head 52, the oil pump 21 and the oil cooler 22 in the oil circulation passageway C3.

However, the present invention is not limited to this. For example, the oil circulation passageway may be a varied circulation passageway configured to include an oil jet that jets oil to the piston incorporated into a portion between the exist side of the cylinder head and the entrance side of the oil cooler in the oil circulation passageway and form a bypass passageway that bypasses the oil jet and to further include incorporated switch means switchable between the passageway via the oil jet and the bypass passageway. In this case, when the engine driving state is the idle sate, the control means may control the witch means to form the circulation passageway including the passageway via the oil jet.

Thus, the driving of the engine can be established more suitably because oil that receives heat from the cylinder head can be jetted from the oil jet and the engine warm-up can be further accelerated.

Embodiment 2 descried above has explained a case where the cooling medium that flows through the cooling medium circulation passageway into which the head side W/J 521 is incorporated. However, the present invention is not limited to this. For example, it is possible to pass the same cooling medium as that passing through the first cooling medium passageway through a cooling medium circulation passageway that includes the second cooling medium passageway and is independent of the cooling medium circulation passageway including the first cooling medium passageway.

Further, it is rational that the control means is achieved by each ECU 70 mainly controlling the engine 50A. For example, the control means may be realized by a hardware such as another electronic controller, an exclusive electronic circuit, or any combinations thereof. Furthermore, for example, the control means may be achieved, as a distributed control means, by hardware such as multiple electronic controllers and plural electronic circuits or a combination of hardware such as an electronic controller and an electronic circuit.

### DESCRIPTION OF REFERENCE NUMERALS

1 Cooling apparatus
11 W/P
12 Radiator
13 Thermostat
14 Flow rate control valve
21 Oil pump
50 Engine
51 Cylinder block
511 Blocks side W/J
52 Cylinder head
521 Head side W/J
61, 62, 63, 64 Partial flow rate control valves
70 ECU

1. An engine cooling apparatus comprising an engine provided with a cylinder block and a cylinder head;
cooling capacity control means capable of suppressing a cooling capacity of the cylinder head without suppressing a cooling capacity of the cylinder block; and
control means performing a control to suppress the cooling capacity of the cylinder head by controlling the cooling capacity control means.

2. The engine cooling apparatus of claim 1, wherein:
a first cooling medium passageway is formed in the cylinder block, and a second cooling medium passageway that is formed in the cylinder head and is incorporated into a second cooling medium circulation passageway different from a cooling medium circulation passageway into which the first cooling medium passageway is incorporated;
the cooling capacity control means controls a flow rate of a cooling medium that flows through the second cooling medium passageway to control the cooling capacity of the cylinder head; and
the control means performs the control in a case where a driving state of the engine is a low rotation and high load state.

3. The engine cooling apparatus of claim 2, wherein the first and second cooling medium passageways are incorporated into mutually different cooling medium circulation passageways, and the cooling medium that flows through the second cooling medium passageway is oil.

4. The engine cooling apparatus of any of claims 1 to 3, wherein the first cooling medium passageway includes a first partial cooling medium passageway in the cylinder block in a periphery of a cylinder provided in the cylinder block, and an upstream portion of the first partial cooling medium passageway is provided so as to correspond to a portion of a wall surface of the cylinder that is hit by intake air flowing into the cylinder.
